(19) United States
(12) Patent Application Publication
(10) Pub. No.: US 2006/0173862 A1
(43) Pub. Date: Aug. 3, 2006

(54) Method and system for displaying context-sensitive columns in a table

(76) Inventor: Volker Sauermann, Dossenheim (DE)

Correspondence Address: KENYON & KENYON LLP, ONE BROADWAY, NEW YORK, NY, 10004, US

(21) Appl. No.: 11/026,241

(22) Filed: Dec. 29, 2004

(51) Int. Cl. G06F 7/00

(52) U.S. Cl. 707/100

(57) ABSTRACT

A method and system for displaying context-sensitive columns in a table of a graphical user interface (GUI) are provided for software running on a processor and being displayed to a user. The context-sensitive columns allow additional information to be displayed in a table on a window of a graphical user interface only when the columns contain information that is relevant. In this manner, the context-sensitive columns are not displayed and do not take up space on the display if they do not contain relevant information thereby freeing the display from unnecessary clutter and possibly reducing the need for horizontal scrolling in a table to view all the columns of data contained therein. For example, an error column may be displayed according to this embodiment only if errors have occurred and are included in one of the cells of the column. The context-sensitive columns may allow a more relevant display of information in the limited display space of a graphical user interface window thereby improving the graphical user interface of the software application.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to a method and system for displaying context-sensitive columns in a table of a graphical user interface viewable on a computer system display.

### BACKGROUND

Software applications running on computer systems implement graphical user interfaces to facilitate the man-machine interface by making the software easier to use. One particular aspect of a graphical user interface (GUI) is the display of data tables with columns of information for each row of the table. Often the columns shown in a table on a GUI screen are a subset of all the columns available for the table and may be termed a table view (as it is only one view or presentation of the table data in the GUI). The columns in a table view are typically selected to provide the most frequently used or most generally applicable information. These default columns are often adequate in displaying the information that a user needs but situations arise where additional information is useful and may be necessary for the user. A user may navigate within the GUI to find this additional information (if it is available) but this requires the user to leave the currently displayed table view which may have other information relevant to the user. During these situations (specific contexts) it would be beneficial to group the relevant columns of data in a dynamic manner for the user and present them on a temporary basis (during the situation or while the context applies) in the current table view. Conventional graphical user interfaces do not provide this capability.

One example of a graphical user interface that incorporates a table view of data is the user interface for a search engine administration software application. FIG. 1 is a diagram illustrating a conventional graphical user interface for a search engine administration software tool. The search engine consists of several servers, index servers, preprocessors, and name servers, running in a distributed environment. New documents are passed to the search engine from a queue in the queue server. The queue server first passes the documents to a preprocessor for preprocessing. The queue server then transfers the documents to an index server where they are indexed and optimized, after which they become visible in a new or already existing index. After the documents are included in an index, they can then be searched.

The graphical user interface 100 for the search engine administration software application may present information in a table view format using tabs 101 to separate functions. In the example shown in FIG. 1, the “Queue Administration” tab 102 is the selected function. Within the “Queue Administration” tab 102, the available queues 103 are listed along with specific information about the highlighted queues 106 shown in the table views provided for the “Queue Info” table 104 sub-tab and the “Queue Parameters” table 105 sub-tab. These two tabs 104, 105 show specific information relating to the highlighted (i.e., selected) queues 106 in the listing of available queues 103. The sequence of steps in processing documents for inclusion in a search engine index are reflected in the columns shown in the “Queue Info” table 104. The columns of the “Queue Info” table 104 show the progress from left to right of documents as they go through the process of being included in a search engine index and becoming searchable. In addition to the “Queue State” column 107, the number of documents to be preprocessed (in the “to be preprocessed” column 108) for the queue are also listed (which corresponds to the first step of identifying documents to be included in the index), the number of documents in preprocessing (in the “Preprocessing” column 109), the number of documents preprocessed but waiting to be indexed (in the “to be indexed” column 110), the number of documents that are being indexed (in the “Indexing” column 111), the number of documents indexed but waiting to be optimized (in the “to be optimized” column 112), the number of documents in the process of being optimized (in the “Optimizing” column 113), and finally the number of optimized documents that are included in a search engine index and are now searchable (in the “Optimized” column 114) are all included for each queue 106 shown in the “Queue Info” table 104. In addition to the data presented in the “Queue Administration” tab 102 of the search engine graphical user interface 100, a number of operations are made available to the user through on-screen buttons 115. These buttons 115 may initiate operations such as flushing the selected queues 106 in the “Queue Info” tab 104 (associated with the “Flush” button 116), activating the selected queues (“Activate” button 117), suspending the selected queues 106 (associated with the “Suspend” button 118), etc. The buttons 115 and pull-down menus enable a user of the search engine administration tool to perform routine administration tasks quickly and easily.

FIG. 1 shows the default view of the “Queue Info” table 104 data. This default view may provide a user with what may be considered pertinent or more frequently usable information in an effort to reduce a user's need to access additional data. In the “Queue Info” tab 104 of the example shown in FIG. 1, the columns are selected and sized so that they all appear on the GUI screen without a user having to horizontally scroll within the table or screen in order to access data columns. This is done in the example along with providing summary information in order to facilitate the presentation of information to the user and to enhance the man-machine interface. It is common for conventional software applications to show a summary view as a default and allow the user to “drill-down” to additional details through one or more selection mechanisms. For example, a user may select (e.g., double-click on) a row of a table resulting in a new or popup window showing additional details for that row of information. In the example shown in FIG. 1, a “Details” check box 119 is provided as one selection mechanism to show greater detail than is otherwise presented in the default summary view shown in FIG. 1.

FIG. 2 is a diagram illustrating a conventional graphical user interface for a search engine administration software tool after a user selects the display of detailed information. In the example shown in FIG. 2, the user has selected the “Details” check box 228 to show greater detail for the queues 106 displayed in the “Queue Info” table 104 of the graphical user interface. The additional columns included in the detailed table view that were not present in the default table view shown in FIG. 1 include a “Last optimize/index” column 220, a “Return Code” column 221, an “Error Message” column 222, a “Delayed” column 223, a “Preprocessing failed” column 224, an “Indexing failed” column 225, and an “Optimizing failed” column (not shown). The inclusion of the additional columns in the detailed table view now requires a user to horizontally scroll in order to see all of the column data. In this example, a check box was used to display more detailed columns of data for the queues. The information could also have been accessed through other tabs, buttons, pull-down menus, etc. Regardless of how the detailed information is accessed, it requires the user to navigate and execute at least one action in the graphical user interface and it does not tailor the display of the columns in a context-sensitive manner. The present invention solves these problems by displaying additional columns in a dynamic manner and on a temporary basis when the column is relevant in the context of a current situation.

### BRIEF DESCRIPTION OF THE DRAWINGS

FIG. 1 is a diagram illustrating a conventional graphical user interface for a search engine administration software tool.

FIG. 2 is a diagram illustrating a conventional graphical user interface for a search engine administration software tool after a user selects the display of detailed information.

FIG. 3 is a diagram illustrating the implementation of context-sensitive columns in a table of a graphical user interface according to one embodiment of the present invention.

FIG. 4 is a diagram illustrating how the selection of a configuration parameter may trigger the display of a context-sensitive column in a table of software application according to one embodiment of the present invention.

FIG. 5 is a diagram illustrating the display of context-sensitive columns resulting from of an unsuccessful change in a configuration parameter according to one embodiment of the present invention.

FIG. 6 is a diagram illustrating the table in which the context-sensitive columns are default columns according to one embodiment of the present invention.

FIG. 7 is a block diagram illustrating the platform on which a graphical user interface displaying the context-sensitive columns may operate according to one embodiment of the present invention.

### DETAILED DESCRIPTION

According to one embodiment of the present invention, a method and system for displaying context-sensitive columns in a table of a graphical user interface (GUI) are provided for software running on a processor and being displayed to a user. The context-sensitive columns allow additional information to be displayed in a table on a window (screen and window are used interchangeably herein) of a graphical user interface only when the columns contain information that is relevant. In this manner, the context-sensitive columns are not displayed and do not take up space on the display if they do not contain relevant information thereby freeing the display from unnecessary clutter and possibly reducing the need for horizontal scrolling in a table to view all the columns of data contained therein. For example, an error column may be displayed according to this embodiment only if errors have occurred and are included in one of the cells of the column. The context-sensitive columns may allow a more relevant display of information in the limited display space of a graphical user interface window thereby improving the graphical user interface of the software application.

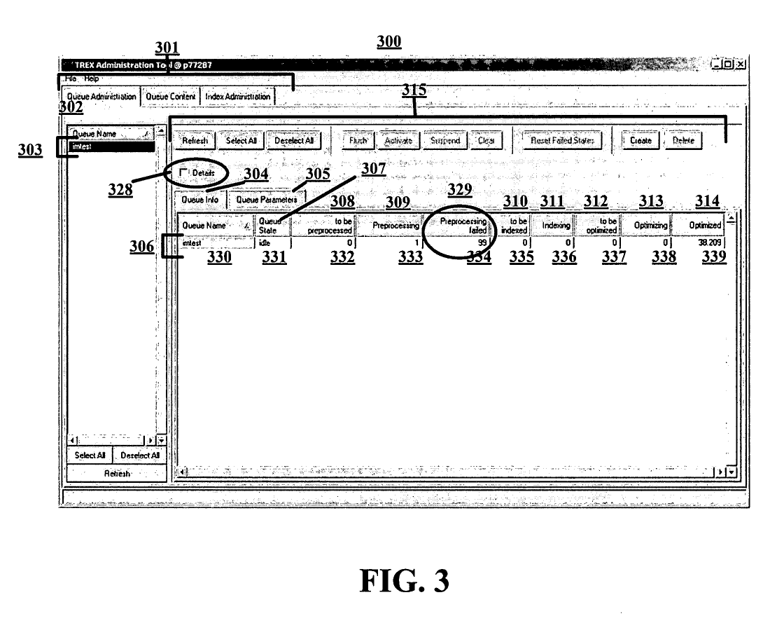

FIG. 3 is a diagram illustrating the implementation of context-sensitive columns in a table of a graphical user interface according to one embodiment of the present invention. The screen or window 300 shown for the graphical user interface is the “Queue Administration” tab 301 data screen of a search engine administration tool as previously discussed. Within the “Queue Administration” tab 301, the “Queue Info” table 304 is shown in a sub-tab on the screen. The display of the “Queue Info” table 304 data can be toggled with the display of the “Queue Parameters” table 305 data by toggling between both the sub-tabs shown. In other examples of a graphical user interface, the table data may be fixed on the screen (and not toggled with other information) or the table may be displayed using options other than tabs that also allow it to be toggled with other data. Whether or not data is toggled between different tables or between table views (e.g., detailed view versus a summary view), this present invention provides enhanced table and data display characteristics improving the information display to a user.

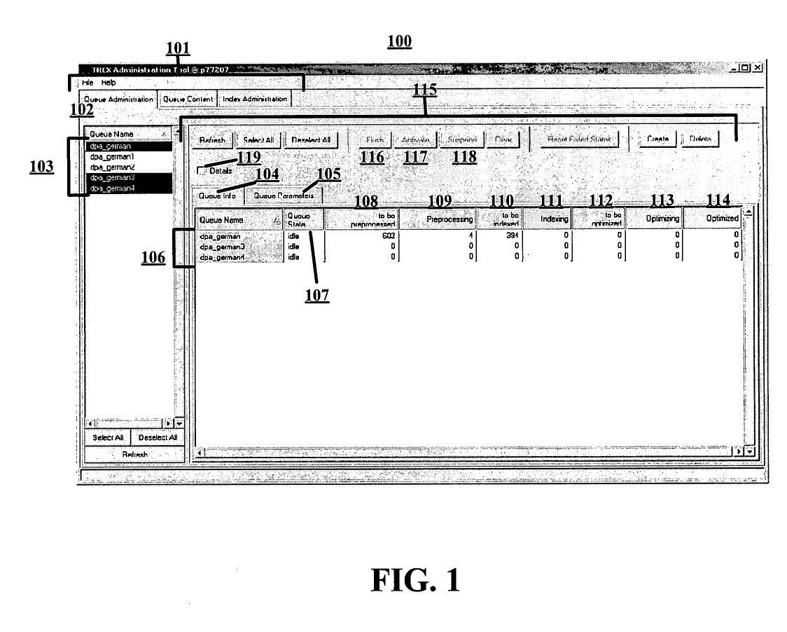

The “Queue Info” table 304 in FIG. 3 contains all of the columns as described for FIG. 1 earlier. These columns include the “Queue State” column 307, the “to be preprocessed” column 308 (showing the number of documents to be preprocessed for the queue), the “Preprocessing” column 309 (showing the number of documents currently undergoing preprocessing), the “to be indexed” column 310 (showing the number of documents already preprocessed but waiting to be indexed), the “Indexing” column 311 (showing the number of documents that are currently being indexed), the “to be optimized” column 312 (showing the number of documents already indexed but waiting to be optimized), the “Optimizing” column 313 (showing the number of documents currently undergoing optimization), and the “Optimized” column 314 (showing the number of already optimized documents that are included in a search engine index and are now searchable). In addition to these columns (the columns that also appeared in FIG. 1), the “Queue Info” table 304 in FIG. 3 also contains one additional column—the “Preprocessing failed” column 329. This additional “Preprocessing failed” column 329 is a context-sensitive column and is displayed according to this embodiment of the present invention because the value of a cell (i.e., the intersection of a row and a column in a table) for this column 329 contains a significant or relevant value—in this case a value greater than 0.

Unlike FIG. 1, there is only one available queue 303 in FIG. 3 (i.e., the imtest queue 306) and, therefore, only the data for this available queue 306 is selected and shown in “Queue Info” table 304. The imtest queue 306 is currently idle 331 (has a “Queue State” 307 of idle 331). There are currently 0 documents 332 waiting “to be preprocessed” 308 and only 1 document 333 that is currently undergoing “Preprocessing” 309. However, there are 99 documents 334 for which “Preprocessing failed” 329 which is a significant number leading to this context-sensitive column being displayed according to this embodiment of the present invention. There are 0 documents 335 waiting “to be indexed” 310 and 0 documents 336 currently undergoing “Indexing” 311. Also, there are 0 documents 337 waiting “to be optimized” 312 and 0 documents 338 currently undergoing “Optimizing” 313. The imtest queue 306 does have 38,209 documents 339 that have already been “Optimized” 314 and are available for searching. Out of all this data, the only ongoing action is the 1 document 333 currently undergoing “Preprocessing” 309. Another very significant piece of information for the user of the search engine administration tool is that 99 documents 334 have failed the preprocessing step 329. The utility of presenting this information directly to the user in the summary of the queue information 304 is apparent. The determinant of whether the “Preprocessing failed” column 99 is displayed in the “Queue Info” table 304 is the values in the cells of the column according to this embodiment of the present invention.

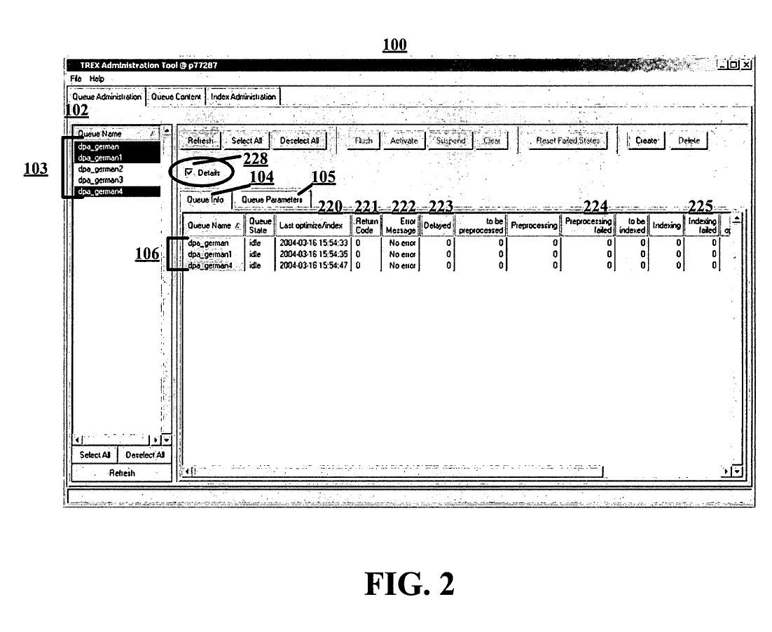

In the example shown in FIG. 3, if any of the cells in any of the error columns in the detailed information for the queue contain a value other than 0 (i.e., if any errors have occurred during one of the steps in the process of including a document into a search engine), the value may be significant and the error column containing the cell may be displayed in the default or main summary data screen in the “Queue Info” table 304 according to this embodiment of the present invention. The error columns in the detailed information for the queue were shown in FIG. 2 and included the “Delayed” column 223, the “Preprocessing failed” column 224, the “Indexing failed” column 225 and the “Optimizing” failed column (not shown). The error columns 224, 225 are self-explanatory and the “Delayed” column 223 shows the number of documents for which the process of being added to a search engine index has not yet begun. These and possibly other detailed columns may also be shown in the “Queue Info” table 304 default or summary screen if those columns have a significant value (e.g., a value greater than 0) in one of its cells. A significant value may be determined by setting a threshold value for each column in the table according to one embodiment of the present invention. Alternatively because certain default columns are already included into the default or summary view for the table, a threshold value may only be necessary for the detailed columns (those not found in the default or summary view of the table) and not for the default columns.

FIG. 3 illustrates only a narrow example of the problem being addressed by the present invention. In many situations involving the display of data in a table on a graphical user interface, a user must navigate to other table views in order for context-specific data to be displayed (for the user to be able to access or view this context-specific or context-relevant data). This may occur because it is not feasible to display all the table information in one particular table view because of, for example, space constraints on the display and/or for organizational reasons where data is grouped according to function or other category. In one embodiment of the present invention, the graphical user interface of a software application alleviates this problem by enriching (adding to) the currently active table view in a dynamic manner and on a temporary basis by adding additional columns of the table that are not normally displayed in the currently active table view. For example, if an error column is normally not part of a currently active table view (e.g., table view X) and error information is contained in one of the error cells of the error column, the error column may be added to currently active table view (e.g., table view X) and displayed to the user on a temporary basis. In general, these context-sensitive columns are typically displayed on other screens or table views in the graphical user interface but accessing this data elsewhere is cumbersome requiring the user to change the display to see the relevant information. The use of context-sensitive columns presents the relevant information to the user in an efficient manner even though those same columns of data may be available elsewhere through the graphical user interface.

A table view or data view as referred to in this specification indicates a particular display of data for a table and may include not only a selection of certain columns (any subset or all the columns of a table) to be included from the table in the table view but may also include changes in the ordering of the columns displayed. A table view may also be referred to interchangeably as a screen of a table or simply as the table. The currently active table view (or current table view) is the table view in which the display of a context-sensitive column has been initiated. The original table view(s) is/are the table view(s) (if any) in which the context-sensitive column is normally displayed by default (not in a dynamic context-sensitive manner).

In one embodiment of the present invention, the intent is not to make the user navigate to information that is relevant in a particular situation or context but to make the context-sensitive information available to the user during the duration of the situation (or while it is relevant in context), whatever that may be. In this manner, a column of data for the table that is normally displayed (or is not displayed at all) in another data or table view (e.g., table view Y) on the GUI is made available in the currently active table view (e.g., table view X) during the duration of a situation or when it is particularly relevant. For example in FIG. 3, the “Preprocessing failed” column 329 is displayed in the default or summary table view of the “Queue Info” table 304 during the error situation where 99 documents 334 have failed preprocessing. The context-sensitive column may still be available in other table views such as the original table view(s) in which it is displayed (e.g., table view Y), it is only added to the currently active table view (e.g., table view X) during its relevancy to the context (i.e., the duration of the situation) according to this embodiment of the present invention. For example, the “Preprocessing failed” column 329 in FIG. 3 may still be displayed in the detailed table view of the “Queue Info” table 304 as shown in FIG. 2. The example embodiment shown in FIG. 3 shows the “Preprocessing failed” column 329 in the “Queue Info” summary table 304 but it is still available in the detailed view of the “Queue Info” table 304 as shown in FIG. 2. In an alternative embodiment of the present invention, a context-sensitive column may be moved in a dynamic manner and on a temporary basis from one table view to another during the duration of a situation (i.e., during its relevancy in a particular context). According to this alternative embodiment, not only does the context-sensitive column appear in the currently active table view (e.g., table view X), it is also no longer displayed in its original table view(s) (e.g., table view Y) during this temporary period of time. For example according to this alternative embodiment, while the “Preprocessing failed” column 329 is displayed in the default or summary table view of the “Queue Info” table 304 it is no longer displayed in the detailed table view of the “Queue Info” table 304 shown in FIG. 2.

According to both this embodiment and the alternative embodiment discussed in the paragraph above, once the situation that prompted the context-sensitive display of the column no longer exists and has returned to normal (i.e., the column data is no longer relevant to this context), the context-sensitive column is no longer displayed in the currently active table view (table view X). Using FIG. 3 as an example, the “Preprocessing failed” column 329 is no longer displayed in the “Queue Info” table 304 default or summary screen (the currently active table view) once there are 0 documents 334 that have failed preprocessing. At this point, adding (or retaining) the display of the context-sensitive column to the currently active table view no longer serves the primary purpose of augmenting the display with additional context-sensitive columns of information on an as needed basis according to these embodiments. Additionally in the alternative embodiment discussed in the paragraph above, not only is the context-sensitive column no longer displayed in the currently active table view once it is no longer relevant to the context (i.e., the situation has returned to normal), but it is now again displayed in its original table view(s). For example in FIG. 3, once there are 0 documents 334 that have failed preprocessing, not only is the “Preprocessing failed” column 329 no longer displayed in the “Queue Info” table 304 default or summary screen but it is also again displayed (returned to) the detailed screen in the “Queue Info” table 304 shown in FIG. 2.

In addition to adding a context-sensitive column in a dynamic manner and on a temporary basis to the current table view as described above, an existing (default) column in the currently active table view (i.e., the table view receiving the context-sensitive column for display) may temporarily be removed from the currently active table view if it is not relevant to the situation or context according to one embodiment of the present invention. In this manner, a column that is not relevant to the situation initiating the display of the added context-sensitive column may be temporarily removed from the display in order to create additional screen or display space for the context-sensitive column(s) that are added to the currently active table view. For example in FIG. 3, if the “Queue State” column 307 is not relevant to the preprocessing error situation giving rise to the context-sensitive display of the “Preprocessing failed” column 329, the “Queue State” column 307 may be removed from the default or summary screen of the “Queue Info” table 304 while the “Preprocessing failed” column 329 is being displayed. In this manner, additional room is made for the new column(s) in the currently active table view. According to this embodiment, the temporarily removed default columns in the currently active table view are again displayed once the situation no longer exists and the context-sensitive columns are no longer displayed in the currently active table view.

In another embodiment of the present invention, the adding of a context-sensitive column to the currently active table view may result in a resizing of the column widths in order to display all the columns on the display device without requiring the user to horizontally scroll within the currently active table view or graphical user interface in order to see all the columns and their associated data. The resizing according to this embodiment may be done on an equal basis for all the columns in the currently active table view or may be done in a more individual manner using relevancy or other values to determine which columns are affected to what degree. For example, all the columns may be narrowed in width by 10% or by some other measure in order to make room for the newly and temporarily added context-sensitive columns. In another example, the more relevant columns may be adjusted in width less than or not at all compared to the less relevant columns when the resizing is done. According to this second example, a method for determining column relevancy is necessary in order to make this calculation. Factors other than or instead of relevancy may be used when determining how columns may be resized when individual (non-equitable) column resizing is used.

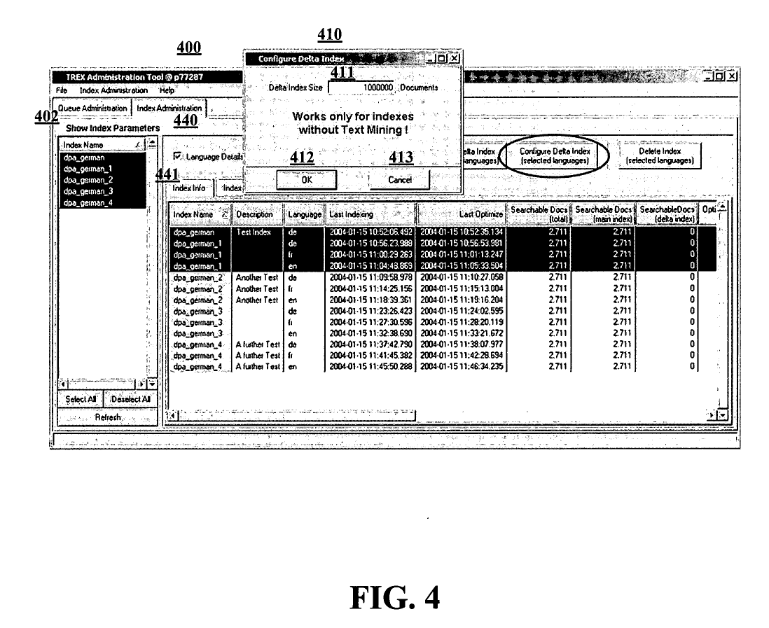

FIG. 4 is a diagram illustrating how the selection of a configuration parameter may trigger the display of a context-sensitive column in a table of software application according to one embodiment of the present invention. In FIG. 4, the “Index Administration” tab 440 is selected and displayed instead of the “Queue Administration” tab 402 shown in FIGS. 1-3 for this search engine administration tool example of a software application GUI. In FIG. 4, the user has selected (clicked on or otherwise chosen) the “Configure Delta Index” option in the “Index Administration” tab 440 of search engine administration tool GUI 400 resulting in a popup window 410 being displayed allowing a user to select the maximum number of documents that may be contained in an index. A default value 411 of 1,000,000 (one million) documents is shown in the popup window 410. If the user cancels the operation 413 (by selecting the “Cancel” button 413), the maximum documents parameter is not changed and there is no resulting change in the default “Index Info” table 441 shown. If the user changes the maximum documents parameter value (by changing the default value 411) and executes the change 412 (by selecting the “OK” button 412), the resulting parameter change may successfully occur for some of the existing indices but it may not be successful for all of the indices. An unsuccessful delta index parameter change may result in the display of one or more context-sensitive columns as a result of a not fully successful operation.

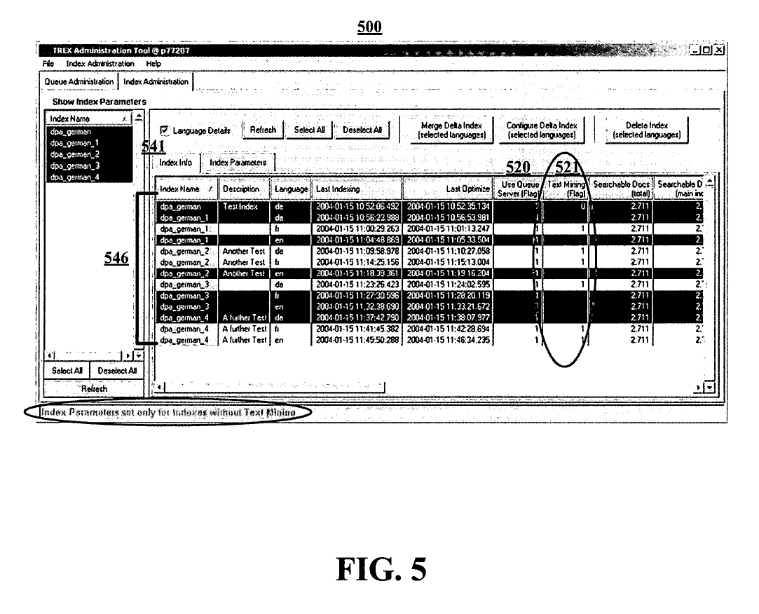

Changing the maximum documents parameter in FIG. 4 initiates the display of context-sensitive columns in the “Index Info” table 441. FIG. 5 is a diagram illustrating the display of context-sensitive columns resulting from of an unsuccessful change in a configuration parameter according to one embodiment of the present invention. Because the change in the maximum documents configuration parameter was not successful for all the indices 546 in the “Index Info” table 541, the “Use Queue Server” column 520 and the “Text Mining” column 521 are displayed as context-sensitive columns in the table view in order to help explain why the parameter change was unsuccessful. The values of both the “User Queue Server” column 520 and the “Text Mining” column 521 determine whether or not the maximum number of documents for an index may be changed. A user knowledgeable in the search engine administration tool will be able to see from the data presented in these context-sensitive columns 520, 521 why the maximum documents parameter change was unsuccessful for some of the indices. Unlike the example provided for the embodiment in FIG. 3, the example shown in FIG. 5 is for informational purposes relating to the context of trying to change a parameter (in this case a maximum documents parameter) and the context-sensitive columns are not displayed as a result of an error situation. For this reason, when the user performs another action in the graphical user interface, these context-sensitive columns 520, 521 may disappear from the “Index Info” table 541 as they are no longer relevant to any new context or situation facing the user. The context in which the display of the columns is initiated may determine how long the context-sensitive columns remain displayed in the currently active table view.

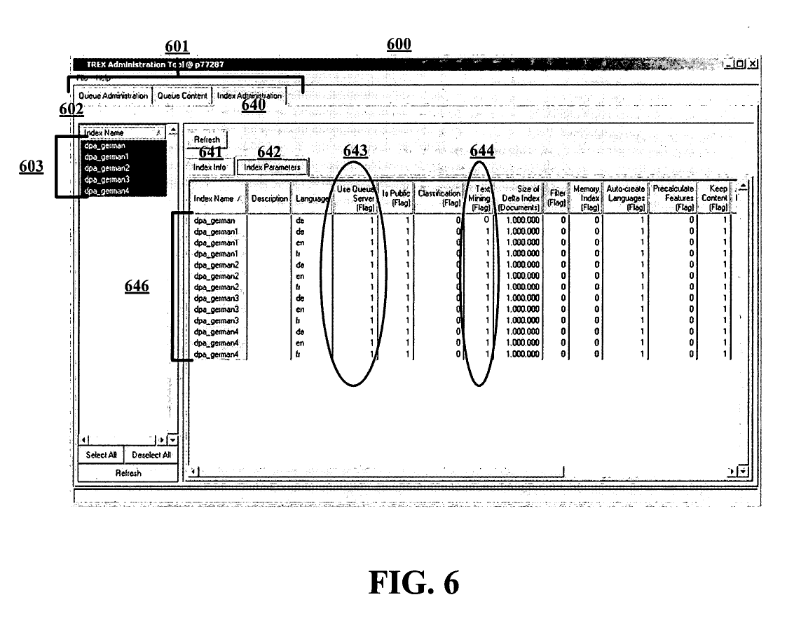

FIG. 6 is a diagram illustrating the table in which the context-sensitive columns are default columns according to one embodiment of the present invention. In FIG. 6, the “Index Parameters” table 642 is displayed in which the “Use Queue Server” column 643 and the “Text Mining” column 644 are normal default columns (i.e., they are not context-sensitive columns that are displayed in a dynamic manner temporarily in the table view). Both these default columns 643, 644 became context-sensitive columns 520, 521 that were displayed in the “Index Info” table 541 in FIG. 5 in the example above. This illustrates that the context-sensitive columns that may temporarily appear in some tables (table views) in the graphical user interface may also be default columns in other tables. Comparing the use of these columns 643, 644 as context-sensitive columns 520, 521 in a currently active table view in FIG. 5 illustrates the convenience to the user who would otherwise have to change tabs to view the information in these columns in order to determine why changing the maximum documents parameter (the delta index value) in FIG. 4 was unsuccessful for some indices.

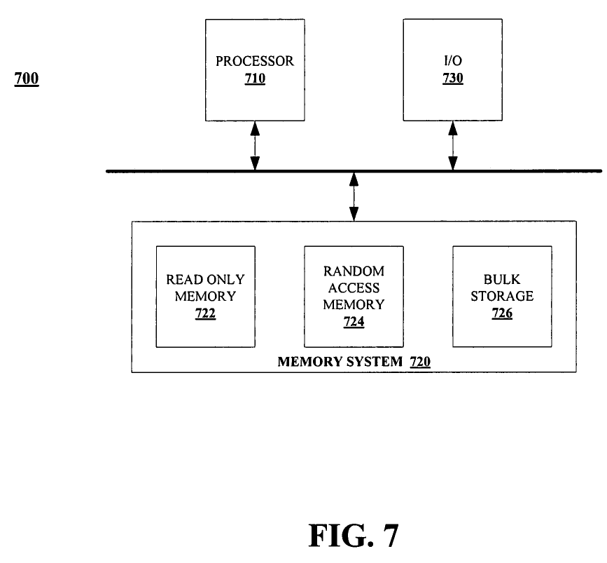

FIG. 7 is a block diagram illustrating the platform on which a graphical user interface displaying the context-sensitive columns may operate according to one embodiment of the present invention. Functionality of the foregoing embodiments may be provided on various computer platforms executing program instructions. One such platform 700 is illustrated in the simplified block diagram of FIG. 7. There, the platform 700 is shown as being populated by a processor 710, a memory system 720 and an input/output (I/O) unit 730. The processor 710 may be any of a plurality of conventional processing systems, including microprocessors, digital signal processors and field programmable logic arrays. In some applications, it may be advantageous to provide multiple processors (not shown) in the platform 700. The processor(s) 710 execute program instructions stored in the memory system. The memory system 720 may include any combination of conventional memory circuits, including electrical, magnetic or optical memory systems. As shown in FIG. 7, the memory system may include read only memories 722, random access memories 724 and bulk storage 726. The memory system not only stores the program instructions representing the various methods described herein but also can store the data items on which these methods operate. The I/O unit 730 would permit communication with external devices (not shown).

What is claimed is:

1. A method for dynamically and temporarily displaying a column in a table of a graphical user interface for a software application viewable on a display device, comprising:
identifying the column containing a relevant data value, the relevant data value applying to a user interaction with the graphical user interface and the software application;
displaying the identified column in the table of the graphical user interface; and
restoring the table of the graphical user interface by removing the column as a function of the column no longer containing a relevant data value.

2. The method according to claim 1, further comprising:
removing an irrelevant column from the table as a function of displaying the identified column in the table; and
restoring the irrelevant column to the table as a function of restoring the table of the graphical user interface.

3. The method according to claim 1, further comprising:
resizing a default column in the table of the graphical user interface as a function of displaying the identified column in the table.

4. The method according to claim 1, wherein the column is an error column containing a relevant data value greater than zero.

5. A method for dynamically and temporarily displaying a column in a table of a graphical user interface for a software application viewable on a display device, comprising:
identifying the column containing a relevant data value, the relevant data value applying to a user interaction with the graphical user interface and the software application;
displaying the identified column in the table of the graphical user interface;
removing the column from an original table view while the column is displayed in the table; and
restoring the table of the graphical user interface and the column in the original table, wherein the table of the graphical user interface is restored by removing the column as a function of the column no longer containing a relevant data value and wherein the column is restored in the original table view as a function of restoring the table.

6. The method according to claim 1, further comprising:
removing an irrelevant column from the table as a function of displaying the identified column in the table; and
restoring the irrelevant column to the table as a function of restoring the table of the graphical user interface.

7. The method according to claim 1, further comprising:
resizing a default column in the table of the graphical user interface as a function of displaying the identified column in the table.

8. The method according to claim 1, wherein the column is an error column containing a relevant data value greater than zero.

9. A display method comprising:
generating a tabular array of data records according to a predetermined table view, the table view identifying fie Ids of the records that are to be included for display;
displaying the tabular array; and
dynamically:
determining whether data of a non-displayed field that is not identified by the table view meets a predetermined criterion, and
if so, altering the display of the tabular array to include a new column corresponding to the non-displayed field and contents thereof.

10. The method according to claim 9, further comprising:
altering the display of the tabular array to remove the new column when the non-displayed field no longer meets the predetermined criterion.

11. A display method comprising:
generating a display of data based on predetermined view definition, the view definition identifying for displayable data records which fields of the data records are to be included in the display initially, and
continuously, for as long as the display is active:
responsive to real-time updates of the data records, comparing values of fields that are not included in the view definition to predetermined criteria, and
if a field of at least one record matches a predetermined criterion, adding the field to the display, and
displaying record data for all fields selected for display.

12. The method according to claim 11, further comprising:
altering the display of data to remove a field that is not included in the view definition when no displayable record value for the field matches a predetermined criterion.

13. A system for dynamically and temporarily displaying a column in a table of a graphical user interface for a software application viewable on a display device, comprising:
a program memory;
a storage device; and
a processor, wherein the processor is adapted to:
(i) identify the column containing a relevant data value, the relevant data value applying to a user interaction with the graphical user interface and the software application;
(ii) display the identified column in the table of the graphical user interface; and
(iii) restore the table of the graphical user interface by removing the column as a function of the column no longer containing a relevant data value.

14. A system for dynamically and temporarily displaying a column in a table of a graphical user interface for a software application viewable on a display device, comprising:
a program memory;
a storage device; and
a processor, wherein the processor is adapted to:
(i) identify the column containing a relevant data value, the relevant data value applying to a user interaction with the graphical user interface and the software application;
(ii) display the identified column in the table of the graphical user interface;
(iii) remove the column from an original table view while the column is displayed in the table; and
(iv) restore the table of the graphical user interface and the column in the original table, wherein the table of the graphical user interface is restored by removing the column as a function of the column no longer containing a relevant data value and wherein the column is restored in the original table view as a function of restoring the table.

15. A computer readable medium including instructions adapted to execute a method for dynamically and temporarily displaying a column in a table of a graphical user interface for a software application viewable on a display device, the method comprising:
identifying the column containing a relevant data value, the relevant data value applying to a user interaction with the graphical user interface and the software application;
displaying the identified column in the table of the graphical user interface; and
restoring the table of the graphical user interface by removing the column as a function of the column no longer containing a relevant data value.

16. A computer readable medium including instructions adapted to execute a method for dynamically and temporarily displaying a column in a table of a graphical user interface for a software application viewable on a display device, the method comprising:
identifying the column containing a relevant data value, the relevant data value applying to a user interaction with the graphical user interface and the software application;
displaying the identified column in the table of the graphical user interface;
removing the column from an original table view while the column is displayed in the table; and
restoring the table of the graphical user interface and the column in the original table, wherein the table of the graphical user interface is restored by removing the column as a function of the column no longer containing a relevant data value and wherein the column is restored in the original table view as a function of restoring the table.
